(19) United States
(12) Patent Application Publication
(10) Pub. No.: US 2012/0166242 A1
(43) Pub. Date: Jun. 28, 2012

(54) SYSTEM AND METHOD FOR SCHEDULING AN E-CONFERENCE FOR PARTICIPANTS WITH PARTIAL AVAILABILITY

(75) Inventors: Jon L. Bentley, New Providence, NJ (US); Anjur S. Krishnakumar, Princeton, NJ (US); Parameshwaran Krishnan, Basking Ridge, NJ (US); Navjot Singh, Denville, NJ (US); Shalini Yajnik, Berkeley Heights, NJ (US)

(73) Assignee: Avaya Inc., Basking Ridge, NJ (US)

(21) Appl. No.: 12/978,739

(22) Filed: Dec. 27, 2010

(51) Int. Cl. G06Q 10/00

(52) U.S. Cl. 705/7.13

(57) ABSTRACT

Disclosed herein are systems, methods, and non-transitory computer-readable storage media for scheduling an e-conference for participants with partial availability. Initially, a system identifies a group of participants for the e-conference. The system receives a declaration of availability for the e-conference from at least one participant of the group. The declaration contains the partial availability of the participant based on time restrictions and topics of interest to the participant. Next, a schedule is determined for the e-conference based on the availability of the participants. Finally, the declarations of availability are displayed to the group of participants. In one aspect, participants update their declarations of availability during the e-conference and a schedule is updated to reflect the new declaration of availability.

### BACKGROUND

1. Technical Field

The present disclosure relates to e-conferences and more specifically to scheduling an e-conference for participants with partial availability.

2. Introduction

In the business world, it is often necessary to conduct meetings with people at other physical locations, including those within the same company and those from different companies. E-conferencing is one method for a group of people to communicate with each other without physically being in the same location. An e-conference is an electronic conference that allows for one or more participants to conference electronically instead of requiring the participants to physically travel to the conference location. Examples of e-conferences can include telephone conferences, video conferences, and other multi-party electronic communication sessions. Utilizing e-conferences significantly reduces the costs of meeting since participants do not need to travel to the conference location. Many businesses and organizations utilize e-conferencing to accomplish their objectives more economically.

To schedule an e-conference, participants send their availability to all other participants and a mutually agreed upon time and date for the e-conference to occur is established by the participants. Optionally, an e-conference participant or scheduler schedules the e-conference based on availability as indicated in a digital calendaring system. Typically, a participant is supplied a phone number and a code that allows them to access the e-conference. At the scheduled time, participants connect to the e-conference.

Typically, when scheduling an e-conference, participants indicate their availability or unavailability for the entire duration of the conference. When participants are not available for the full duration of the e-conference, tracking their availability is difficult, cumbersome and time consuming. These problems can also arise during the e-conference as a moderator and/or participants decide what order to go through agenda items, for example.

E-conference participants schedule their availability for an e-conference by sending their availability to all other participants and a mutually agreed upon time and date is established for the e-conference. For example, when Alice, Bob and Chris want to set-up an e-conference, Alice sends her availability to Bob and Chris; Bob sends his availability to Alice and Chris; and Chris sends his availability to Alice and Bob. Oftentimes, numerous messages between the participants are required to successfully set-up an e-conference. Optionally, a participant or other person such as a secretary may use a digital calendaring system such as Microsoft Exchange to determine a time that all of the participants are available. When a person uses a digital calendaring system to set-up an e-conference, they typically look for a block of time when all the participants can attend the entire e-conference. What is missing from a calendaring system such as this one is the ability for participants to indicate their partial availability.

When participants are not available for the full duration of the e-conference, tracking their availability is difficult, cumbersome and time consuming. When a participant is available only for part of an e-conference, there is no efficient way to schedule the e-conference such that the participant is present for the part of the conference that is pertinent to that participant.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for scheduling an e-conference for participants with partial availability. The method is discussed in terms of a system implementing the method. The system enables participants to utilize a user interface to declare their availability for the e-conference. The system first identifies a group of participants for the e-conference. The system identifies the participants in the group through automated caller identification, voluntary participant identification, moderator input or automated speech recognition technology. Through the user interface, the participants declare their availability indicating dates and times available and topics of interest to the respective participants. The system determines a schedule for the e-conference based on the availability of the participants and displays the availability to the group of participants.

Participants view the availability of other participants in the e-conference via the user interface. Participants can declare their availability via a web interface, a smartphone application, an interactive voice response (IVR) system, a text message, an email, a natural language instruction, an instant message, and so forth. Participants can declare their interest in specific agenda items, and the system schedules the agenda accordingly and/or assists a human by suggesting proposed schedules for the entire agenda or for one or more specific items in the agenda. Additionally, the moderator or other participants can indicate the required participation of certain conference attendees for specific agenda items. The system can analyze the availabilities and interests of each participant and generate a schedule that is the most time efficient and/or cost efficient. The system can generate or suggest an agenda based on optimizing for one or more other factors, such as minimizing the required time for a particular subset of the participants (such as hourly-paid contractors).

In another aspect, the system updates the availability of participants during the e-conference. The system receives an updated declaration of availability during the e-conference from one or more participants, and displays the updated availability declarations accordingly. Updating the availability list during the e-conference allows participants to more effectively manage their time and accomplish goals.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example e-conference scheduling method embodiment;

FIG. 3 illustrates an example web-interface system embodiment;

FIG. 4 illustrates an example e-conference agenda;

FIG. 5 illustrates updating participant availability method embodiment;

FIG. 6 illustrates an example availability list; and

FIG. 7 illustrates an example e-conference user interface.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

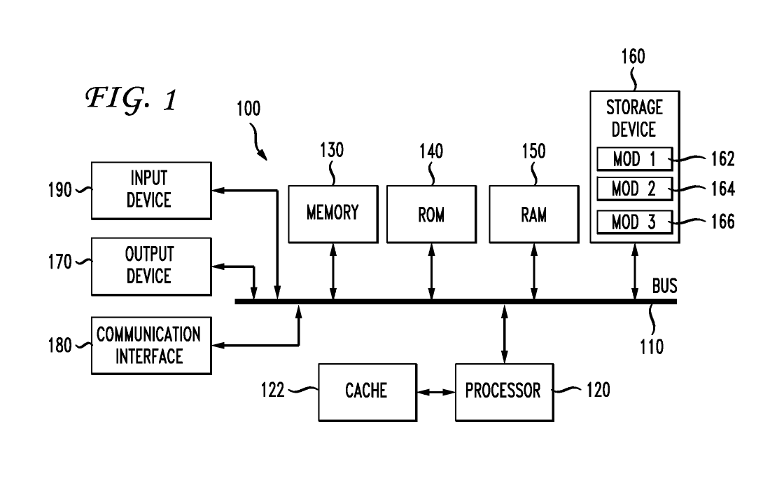

The present disclosure addresses the need in the art for scheduling an e-conference for participants with partial availability. A system, method and non-transitory computer-readable media are disclosed which enable participants in an e-conference to utilize an interface to declare their availability for the e-conference. Participants can view the availability of all other participants through a user interface. A brief introductory description of a basic general purpose system or computing device in FIG. 1 which can be employed to practice the concepts is disclosed herein. A more detailed description of scheduling an e-conference for participants with partial availability will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

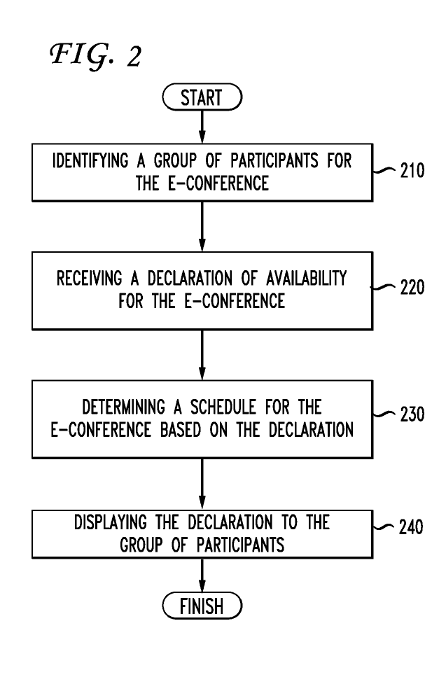

Having disclosed some basic system components and concepts, the disclosure now turns to the exemplary method embodiment shown in FIG. 2. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

Having disclosed some components of a computing system, the disclosure now turns to FIG. 2, which illustrates scheduling an e-conference for participants with partial availability. An e-conference is a communication session with at least one participant and zero or more moderators, and can include, for example, telephone conferences. E-conferences can include conferencing using voice over IP, video conferences, mixed media conferences, instant messaging, telephone, and other communication platforms. Scheduling an e-conference for participants with partial availability starts with the system identifying a group of participants for the e-conference 210. The system can identify a group of participants in several ways. The system can identify a group by caller ID when each participant connects via a separate telephone line. The system can identify a group by prompting the participants to identify themselves, or by having a moderator identify each of the participants in the group. Alternately, the participants may be identified by a voice recognition system. The different methods listed that a system identifies a group is an example, other methods exist and the methods listed should not be limiting in any way.

Participants can be people all over the world, including those both within and outside of a company or organization. The number of participants is effectively only limited by technology constraints. Each participant generates a declaration of availability stating specific dates and times of availability or unavailability. Participants can specify dates and times of availability as hard or soft. A hard deadline is one that does not change whereas a soft deadline can change, such as a desired deadline that is flexible if more important deadlines come up. For example, a participant can specify a time frame they are not available as a hard deadline, indicating to others that an agenda item requiring that participant should not be discussed when the participant is not available, because their deadline will not change. A participant can specify a time frame as a soft deadline which indicates that the participant may be able to change the deadline. For example, Alice may indicate that she is available from 10:00 AM to 11:00 AM as a soft deadline. Labeling this time frame as a soft deadline indicates that she may be available past eleven or prior to ten, for example. She may have indicated 11:00 AM as the time she would like to end the e-conference but that she may extend past eleven if it were necessary.

Participants can declare their availability via a web interface, a smartphone application, a text message, an email or interactions with an email client, a natural language instruction, IVR, an instant message, and so forth. Participants can declare their availability both prior to and during the e-conference. There is no limit to the number of declarations a participant may make. Once a participant declares their availability for the e-conference, the system receives a declaration of availability for the e-conference from one or more participants 220. Next, the system determines a schedule for the e-conference based on the declarations of availability received 230. When a schedule for the e-conference already exists the schedule is updated to reflect the most recent declaration of availability. Lastly, the system displays the declarations through the user interface to all of the participants in the e-conference 240.

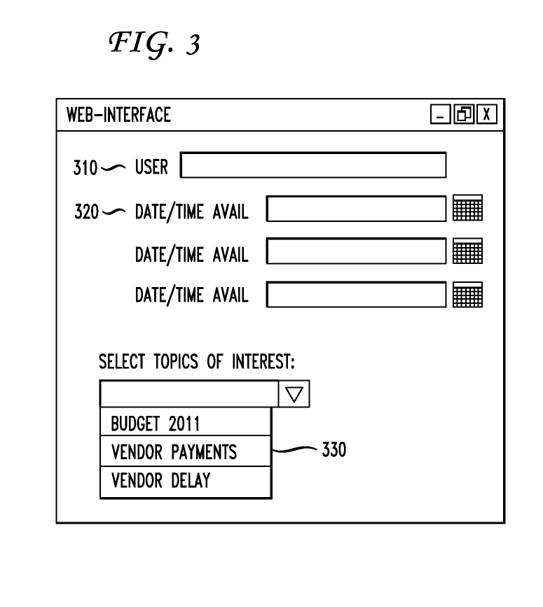

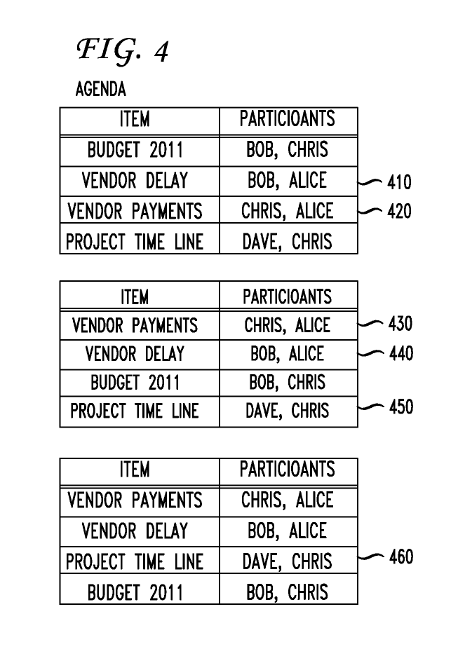

FIG. 3 illustrates an example web interface for a participant to declare their availability for an e-conference. FIG. 4 illustrates an example e-conference agenda. The web interface to the conference scheduling system can include sections for a participant's name 310 and several slots for dates and times available for the e-conference 320. The interface can optionally include an area for a participant to indicate the topics of interest 330 that will be discussed during the e-conference. For example, user Alice enters her name and several dates and times available for the e-conference 320. She also indicates that she is only interested in the vendor payments and vendor delay items of the agenda 330. The system 100 can schedule agenda items that require the participation of Alice during the first twenty minutes of the e-conference to allow Alice to leave the conference after the agenda items are discussed that she is interested in. For example, prior to Alice indicating her availability for the e-conference, the system schedules the agenda such that the participants first discuss Budget 2011, secondly vendor delay 410 and lastly, vendor payments 420. After Alice indicates that she is only available for the first twenty minutes of the e-conference, the system reorders the agenda so that items that require the participation of Alice are discussed first 430, 440 and moves the agenda items that are of no interest to Alice to the end of the e-conference. This method allows for Alice to only discuss the necessary agenda items and then disconnect from the e-conference.

In addition to specifying interest in certain agenda items, participants of the group may require that other participants are present for certain items on the agenda. For example, the moderator may require that Alice and Bob be present for the entire duration of the e-conference. Additionally, Alice may require that Bob is present during the discussion of the budget. The system 100 schedules the e-conference accordingly. In one aspect, another participant or a subset of participants requires that specific participants are present for certain agenda items or time frames.

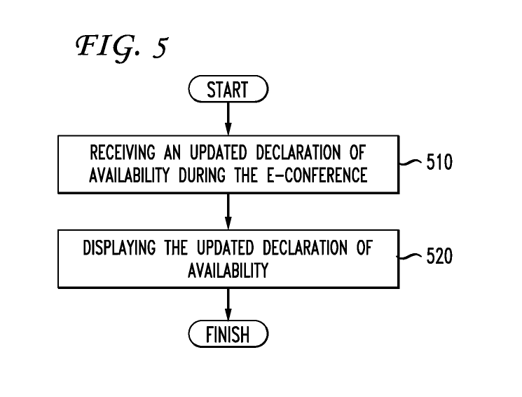

FIG. 5 illustrates updating a declaration of availability during an e-conference. During an e-conference, a participant can update their declaration of availability. The participant updates their declaration of availability via a web interface, a smartphone application, a text message, an email, a natural language instruction, an IVR instruction, an instant message, and so forth. The system 100 receives an updated declaration of availability 510 during the e-conference 410 and displays the updated declaration of availability to the participants 520 based on the updated availability. For example, during the first five minutes of the e-conference while the group discusses vendor payments, Dave receives a message that he needs to attend an impromptu meeting during the last twenty minutes of the e-conference. Dave updates his declaration of availability and the system displays Dave's updated declaration of availability to the participants in the e-conference. Additionally, the system updates the agenda to reflect Dave's new declaration of availability. Originally, Dave was scheduled to participate in the discussion on the project timeline at the end of the e-conference 450. The e-conference agenda is manually or automatically updated so that the project timeline is discussed in time for Dave to leave for his meeting 460.

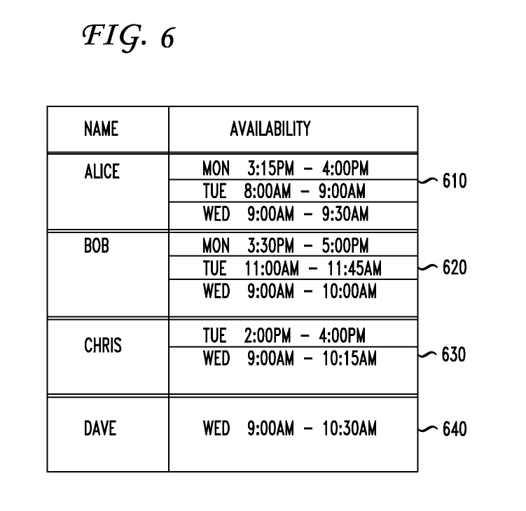

FIG. 6 illustrates an example availability list. Once participants declare their availability for the e-conference, the system displays the availability list for all or a subset of participants to view. The moderator can manually schedule the agenda to meet all of the participant's needs, or the system can automatically produce an agenda based on the availability list. For example, using the availability list to schedule the e-conference for Alice, Bob, Chris and Dave, the system determines that Alice 610 is available on Wednesday from 9:00 AM to 9:30 AM; Bob 620 is available on Wednesday from 9:00 AM to 10:00 AM; Chris 630 is available Wednesday from 9:00 AM to 10:15 AM and Dave 640 is available Wednesday from 9:00 AM to 10:30 AM. The moderator can manually schedule the agenda to meet all of the participant's availability, or the system can automatically schedule the agenda. Utilizing the scheduling system in this way is beneficial to all the participants since it is necessary only for each participant to enter the times they are available before a date, time and optionally agenda are established. Using traditional methods to establish availability would require several messages between e-conference participants before an acceptable time for the e-conference is established. If availability were established using a digital calendaring system, the system would schedule the e-conference for 9:00 AM to 9:30 AM; the only time all four participants are available. Utilizing the e-conference scheduling system is a more efficient use of participant's time since it may not be necessary for each participant to be present for the entire duration of the e-conference.

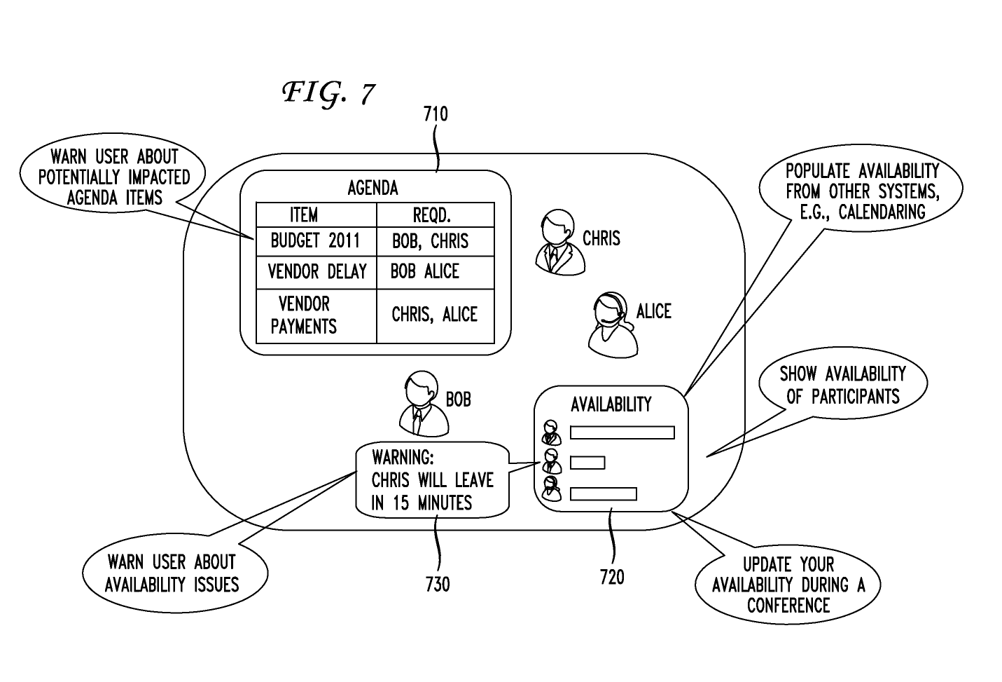

FIG. 7 illustrates an example user interface for scheduling an e-conference for participants with partial availability. The user interface shows an example agenda with items and names of participants required to discuss specific items 710. The interface displays which participants are currently connected to the e-conference, Alice, Chris and Bob and displays their current availability 720. The availability can be populated from multiple sources such as a calendaring system and manual input by the participant. Additionally, the interface illustrates that a participant may update his availability during the e-conference. The interface is also used to warn users of the impending departure of a participant 730. FIG. 7 is simply an example user interface, and should not be limiting in any way.

In addition to scheduling the availability of participants, the system 100 can send reminder messages before, during or after the e-conference, via the scheduling system, email, text message, etc. to other participants reminding them of upcoming events, such as pending departures of participants or changes to the agenda. Sending a reminder message of the pending departure of a participant allows other participants to discuss necessary items with the departing participant before they depart from the e-conference, as is the case with Dave in FIG. 4. Dave receives a message during the e-conference that he needs to attend an impromptu meeting and updates his availability. The system can dynamically modify the agenda to reflect Dave's new availability. Participants that must discuss an agenda item with Dave before he leaves are aware of his new availability and can act accordingly.

The system 100 can send messages to participants of agenda changes to allow participants to more effectively manage their time. For example, the system can notify participants that the budget agenda item has dropped from the third item to the fifth item on the agenda. Those participants only interested in discussing the fifth item can leave and rejoin the conference at an estimated time when the budget will be discussed. In one aspect, changes to the agenda are only made after the approval by the e-conference moderator or by consensus of participants. The system can call the participants when the agenda item is going to come up for discussion. The system can include the indication from the participant that they will drop from the conference call and need to be added when the item of interest comes up.

In addition to sending reminder messages to participants of the e-conference, the system 100 can maintain statistics on how users provide their availability information to detect misuse of the privilege by others. It can optionally maintain other statistics such as the number of participants, the participant who spoke the most, the topics most frequently discussed, average length of e-conferences, number of times the agenda is reordered, etc. The system can make the statistics available to only the moderator, a subset of participants or all participants during or after the e-conference. For example, the system can maintain statistics on the frequency with which participants are speaking and store and/or visually display the results to all participants so participants can monitor how much they speak during the call. In another example, the system can maintain statistics on topics that are discussed most frequently during the call, and display the statistics to allow the participants to stay on topic. The system 100 can utilize the statistics to make future e-conferences more productive. For example, if the system frequently sees the agenda item called budget on an agenda, it can track how much time is spent discussing the budget and schedule accordingly in the future. If the average length of discussion on the budget is typically ten minutes, the system can schedule ten minutes for discussing the budget in future e-conferences where the budget appears on the agenda. This way, participants who are not interested in discussing the budget have a better estimate of how long the discussion will take place, and can act accordingly, such as joining the e-conference after the budget is discussed.

In another aspect, through the scheduling system participants can specify their interest in specific agenda items in the case where a participant is unable to attend the e-conference. The system can record the agenda items when they are discussed for a participant to listen to at a later time. This allows a participant to listen to only the parts of the e-conference they are interested in, instead of the entire e-conference. For example, Alice can indicate that she is only available for the first two items on the agenda but that she would like to later listen to the discussion on the agenda item that she misses: the budget. The system records the budget for Alice to listen to at a later time, and Alice only has to listen to the agenda item that she specified interest in, instead of the entire call. The system can identify topics that are being discussed at any time by automated speech recognition technology or indication from the moderator or participants. In another embodiment, the system may record the entire call and identify parts of the call relating to topic, speaker or time frame for later use. For example, the system can identify all of the areas in the recording that the budget is discussed. After the e-conference, Alice may only review the part of the e-conference relating to the budget. Alternately, the system can identify when Bob is speaking. If Alice is only interested in what Bob says, she may only review those items discussed with Bob.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of scheduling an e-conference for participants with participant availability, the method comprising:
identifying a group of participants for the e-conference;
receiving a declaration of availability for the e-conference from at least one participant of the group to yield at least one declaration, the declaration comprising at least one of a first restriction based on a topic and a second restriction based on a portion of time a respective participant is available during the e-conference;
determining a schedule for the e-conference based on the at least one declaration; and
displaying the at least one declaration to the group of participants.

2. The method of claim 1, wherein the at least one declaration is utilized prior to and during the e-conference to determine scheduling.

3. The method of claim 1, wherein the declaration of availability indicates an interest of a particular participant in a specific agenda item.

4. The method of claim 1, wherein the e-conference is a communication session with at least two participants.

5. The method of claim 1, wherein a moderator indicates a participation requirement for at least one participant.

6. The method of claim 1, further comprising receiving, from a first participant, an indication of required participation of a second participant.

7. The method of claim 1, wherein the at least one declaration comprises action items.

8. The method of claim 1, further comprising computing an agenda schedule based on the at least one declaration.

9. The method of claim 1, further comprising maintaining statistics describing how participants make declarations of availability.

10. The method of claim 1, wherein, as part of the declaration of availability, the respective participant specifies interest in a portion of the e-conference for recording while the respective participant is unavailable.

11. A system for scheduling an e-conference for participants with partial availability, the system comprising:
a processor;
a first module configured to identify a group of participants for the e-conference;
a second module configured to control the processor to receive a declaration of availability for the e-conference from at least one participant of the group to yield at least one declaration, the declaration comprising at least one of a first restriction based on a topic and a second restriction based on a portion of time a respective participant is available during the e-conference;
a third module configured to control the processor to determine a schedule for the e-conference based on the at least one declaration; and
a fourth module configured to control the processor to display the at least one declaration to the group of participants.

12. The system of claim 11, wherein the at least one declaration is utilized prior to and during the e-conference to determine scheduling.

13. The system of claim 11, wherein the declaration of availability indicates an interest of a particular participant in a specific agenda item.

14. The system of claim 11, wherein the e-conference is a communication session with at least one participant and at least zero moderators.

15. The system of claim 11, wherein a moderator indicates a participation requirement for one or more participants.

16. A non-transitory computer-readable storage medium storing instructions which, when executed by a computing device, cause the computing device to schedule an e-conference for participants with partial availability, the instructions comprising:
identifying a group of participants for the e-conference;
receiving a declaration of availability for the e-conference from at least one participant of the group to yield at least one declaration, the declaration comprising at least one of a first restriction based on a topic and a second restriction based on a portion of time a respective participant is available during the e-conference;
determining a schedule for the e-conference based on the at least one declaration; and
displaying the at least one declaration to the group of participants.

17. The non-transitory computer-readable storage medium of claim 16, the instructions further comprising receiving, from a first participant, an indication of required participation of a second participant.

18. The non-transitory computer-readable storage medium of claim 16, the instructions further comprising computing an agenda schedule based on the at least one declaration.

19. The non-transitory computer-readable storage medium of claim 16, the instructions further comprising maintaining statistics describing how participants make declarations of availability.

20. The non-transitory computer-readable storage medium of claim 16, wherein, as part of the declaration of availability, the respective participant specifies interest in a portion of the e-conference for recording while the respective participant is unavailable.
